(19) United States
(12) Patent Application Publication
(10) Pub. No.: US 2015/0052726 A1
(43) Pub. Date: Feb. 26, 2015

(54) Safety Appliance for a Downhaul Weight

(71) Applicants: David A. Camp, Cokato, MN (US); Chris R. Johnson, Cokato, MN (US); Darin L. Young, Dassel, MN (US)

(72) Inventors: David A. Camp, Cokato, MN (US); Chris R. Johnson, Cokato, MN (US); Darin L. Young, Dassel, MN (US)

(73) Assignee: MACHINING & WELDING BY OLSEN, INC., Minneapolis, MN (US)

(21) Appl. No.: 13/973,481

(22) Filed: Aug. 22, 2013

(51) Int. Cl. F16M 11/22; B65D 19/44; B66C 1/10

(52) U.S. Cl. CPC F16M 11/22; B66C 1/10; B65D 19/44
USPC 29/426.1; 211/13.1; 211/85.8; 294/67.1

(57) ABSTRACT

A safety appliance for a downhaul weight. The safety appliance includes a cradle that is configured and arranged to receive support a downhaul weight in its normal working orientation. The safety appliance is capable of receiving and supporting downhaul weights having different sizes and dimensions. When a downhaul weight is seated in the cradle, the safety appliance may provide a working space therebelow. The cradle of the safety appliance may include friction reducing material that allows a downhaul weight to be manipulated while it is seated in the cradle. The safety appliance and a downhaul weight may be conveyed from one location to another location as a single unit. The safety appliance may include one or more box-beams that facilitate lifting the safety appliance from below and/or one or more lifting lugs that facilitate lifting the safety appliance from above.

### BACKGROUND

This application relates generally to downhaul weights, which are also known as overhaul weight, headache balls, blocks, sheaves and the like. More particularly, this application relates to an appliance used to receive, store and transport a downhaul weight in a secure manner. Even more particularly, this application relates to an appliance and method of using the appliance to facilitate removal and/or attachment of a downhaul weight to a cable of a crane.

In many industries cranes are used to lift and move loads from one location to another location. Such cranes include a cable that is able to lift the desired load. The cable is usually a wire rope that comprises a plurality of helically wound strands, which are composed of smaller wires that are also helically wound about each other. When such a cable is connected to a crane and the free end is payed out prior to attachment to or removal from a load, the free end can be difficult to control and may swing about in a dangerous manner. This problem is generally addressed by providing the cable with a downhaul weight that stabilizes the cable. The downhaul weight, which is connected adjacent to the free end of the cable, places the cable under tension and tends to reduce swinging so the cable end is easier to manipulate. When a crane is finished with a job, it is moved from the job site. Prior to moving, the crane is usually dismantled into smaller components that are secured to the crane or other suitable transport. Sometimes, in the case of a small downhaul weight, the downhaul weight is left attached to the cable. This is not, however, advisable because if the cable, to which the downhaul weight is connected, is accidentally released while in transit, there is a chance that both the downhaul weight and the cable could become loose and end up on the road where it might cause an accident and/or serious bodily injury. More often than not, though, in preparation of moving, the downhaul weight is removed from the cable and stowed. This usually entails placing the downhaul weight onto a wooden pallet and securing it thereto by whatever materials happen to be at hand, as for example, tie down straps or baling wire. This, too, has its disadvantages because a downhaul weight-can be quite heavy, (sometimes weighing hundreds of pounds) and after it is placed onto a pallet, it may be necessary to reposition and re-secure the downhaul weight in a different orientation and/or location on the pallet. Moreover, if a downhaul weight is not carefully positioned onto a pallet, it can readily damage slats of a pallet on which it is placed. Even a slight impact may cause one or more of the slats of the pallet to crack. If a pallet is used more than once, a cracked slat can be subject to outright fracture. When this occurs, it can compromise the load carrying ability of the pallet. It is not uncommon for a wooden pallet to be used just one time before having to be replaced replace it with another wooden pallet. Even if a downhaul weight does not damage a pallet, securing the downhaul weight to the pallet can be problematic. A pallet is substantially planar and does not offer any substantial resistance to external lateral forces. Resistance to external lateral forces, therefore, falls to the baling wire or straps used to secure the downhaul weight to the pallet. This presents two problems. First, the baling wire or strap must be arranged so that it is able to secure the downhaul weight to the pallet and also so that it is able to resist external lateral forces that might develop or might be encountered from different directions. This requires some amount of skill in that the baling wire or strap needs to be arranged so that it is able to prevent the downhaul weight from being accidently dislodged from the pallet in both vertical and horizontal directions. Second, since the baling wire or strap needs to be put under significant tension in order to secure the downhaul weight onto a pallet, this might require the use of special tools and handling. Further, besides being difficult to work with, bailing wire or strapping can become unintentionally damaged, be weakened by fatigue, corrode, oxidize, stretch, etc. and for the most part cannot always be safely reused.

The use of wooden pallets to secure and transport downhaul weights presents problems that are in need of solutions. There is a need for an appliance that can be used to receive and seat a downhaul weight in an upright, working condition. There is a need for an appliance that is able to support a downhaul weight so that it may be accessed and worked on from above and below. There is a need for an appliance that is able to capture and retain a downhaul weight so that it can be moved to another location in a safe, secure manner. There is a need for an appliance that facilitates attaching and detaching a downhaul weight to a lifting cable in a controlled, predictable manner. And, there is a need for an appliance that can accommodate differently sized downhaul weights.

### SUMMARY

A safety appliance is disclosed for use in securing and moving a downhaul weight from one location to another location. The appliance includes a cradle with a plurality of upwardly divergent and radially arranged frame members that are configured and arranged to support a downhaul weight in a position that facilitates attachment and/or removal from a lifting cable of a crane. In some embodiments, the frame members of the safety appliance may be provided with one or more friction reducing elements that enable a downhaul weight to be manipulated within the appliance without having to reduce the contact forces between the downhaul weight and the frame members, such as, for example, by applying a vertical lifting force to the downhaul weight. The provision of one or more friction reducing elements can allow a downhaul weight to be repositioned so that elements of the downhaul weight can be inspected and serviced. Alternatively, in some embodiments of the invention, downhaul weight components may be accessed from below and/or from the sides.

In some embodiments, the downhaul weight may be secured to the safety appliance by one or more retaining members that are configured and arranged to prevent accidental dislodgement of the downhaul weight from the safety appliance. In some embodiments, the safety appliance may be inverted so that it may accommodate differently configured and sized downhaul weight. Some embodiments of the safety appliance may include lifting lugs that may be connected to a lift sling or similar device so that the safety appliance or the safety device and a downhaul weight may be lifted and moved from above between a first position and a second position. Other embodiments of the safety appliance may include one or more rails or box beams or pedestals that elevate the safety device so that a downhaul weight may be indirectly lifted and moved from below.

### DESCRIPTION OF THE DRAWINGS

FIG. 1 is a perspective view of an embodiment of a safety appliance;

FIG. 2 is a perspective view of the safety appliance of FIG. 1, with some parts shown in phantom;

FIG. 3 is a top plan view of an alternate embodiment of the safety appliance of FIG. 1;

FIG. 4 is a perspective view of a second embodiment of a safety appliance;

FIG. 5 is a top plan view of an alternate embodiment of the safety appliance of FIG. 4;

FIG. 6 is a perspective view of a third embodiment of a safety appliance;

FIG. 7 is an alternative embodiment of the safety appliance of FIG. 6;

FIG. 8 is a top plan view of the safety appliance of FIG. 7;

FIG. 9 is a perspective view of a safety appliance in use with a crane;

FIG. 10 is a cross-sectional, exploded view of an alternative embodiment of a safety appliance of the third embodiment shown in FIG. 6, in use with a large downhaul weight;

FIG. 11 is a cross-sectional, exploded view of an alternative embodiment of a safety appliance of the third embodiment shown in FIG. 6, in use with a small downhaul weight; and

FIG. 12 is a perspective view of a fifth embodiment of a safety appliance in use with a downhaul weight as it may be positioned on the safety appliance and prior to lifting by a sling.

### DETAILED DESCRIPTION

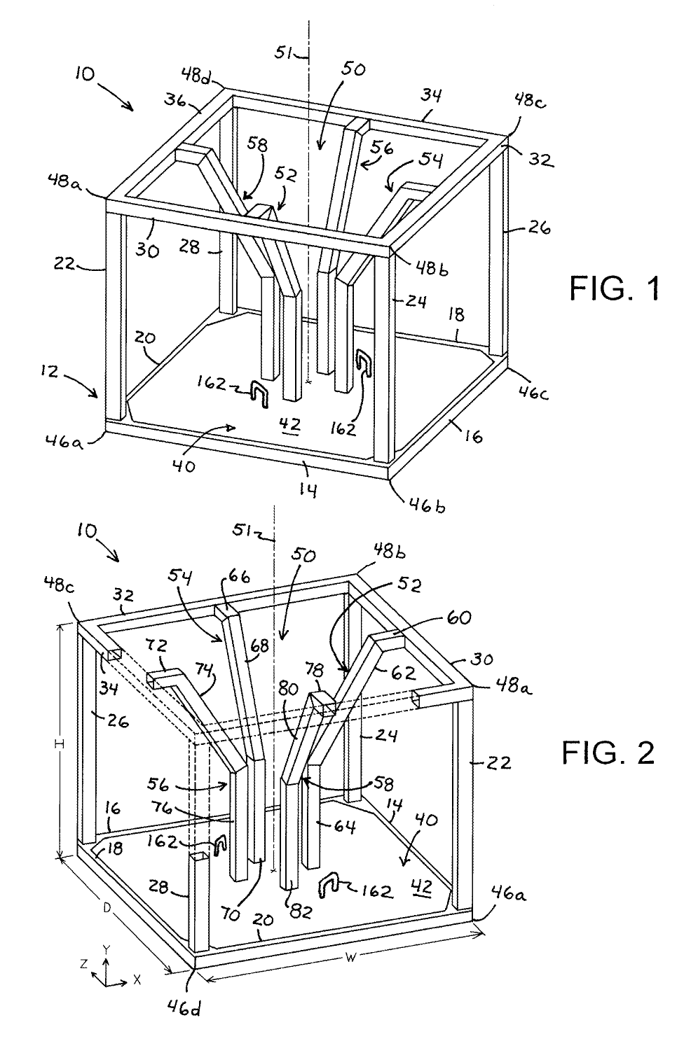

FIG. 1 represents an illustrative first embodiment of a safety appliance 10. The safety appliance 10 has a framework that may include elements such as a base 12 and elements such as lower crossbeams 14, 16, 18, 20 that are connected to each other, preferably by welding, and in a generally quadrilateral configuration. As shown, crossbeam 14 is connected to crossbeams 16 and 20, crossbeam 16 is connected to crossbeams 14 and 18, and crossbeam 18 is connected to crossbeams 16 and 20. In some embodiments, the lower crossbeams 14, 16, 18 and 20 are dimensioned so that they approximate the footprint of a portable platform such as a pallet (where a width W can range from approximately 36″ to approximately 48″ and a depth D or length can range from approximately 36″ to approximately 48″ as illustrated in FIG. 2). The safety appliance 10 may also include one or more posts 22, 24, 26, 28 having lower ends that may be connected to the base 12, preferably by welding, and oriented so that they extend thereabove. Together, the lower crossbeams and the posts form a plurality of lower vertices 46a, 46b, 46c and 46d. Preferably, the posts 22, 24, 26, 28 are substantially vertically oriented and parallel to each other. The safety appliance 10 may also include elements such as upper crossbeams 30, 32, 34, 36 that are connected to each other, preferably by welding, and in a generally quadrilateral configuration. As shown, crossbeam 30 is connected to crossbeams 32 and 36, crossbeam 32 is connected to crossbeams 30 and 34, and crossbeam 34 is connected to crossbeams 32 and 36. The upper crossbeams are connected to upper ends of the posts 22, 24, 26, 28 and together they form a plurality of upper vertices 48a, 48b, 48c and 48d. Preferably, the upper crossbeams have dimensions similar to the lower crossbeams so that the lower crossbeams, the upper crossbeams and the posts define a generally cuboid or cubic structure having a width W, a height H, a depth or length D, and an interior space as shown in FIG. 2. Similar to the width and length (W and D) dimensional ranges, the height H of the cuboid structure can range from approximately 15″ to approximately 48″. While a safety appliance need not be cuboid or cubic in shape, a cubic or cuboid shape is preferred. Such configurations allow safety appliances to be arranged compactly in rows and/or stacked in columns. Some embodiments of the safety appliance 10 may be provided with a platform 40 that may be attached to the lower crossbeams 14, 16, 18 and 20. Advantageously, the platform 40 adds strength to the safety appliance and provides an upper surface 42 which can define a working surface and upon which a cradle 50 may be situated.

With reference to FIG. 2, the cradle 50 may include a plurality of elements such as frame members. In an illustrative embodiment, there are four frame members 52, 54, 56, 58. Each frame member may include elements such as a finger, an arm and a leg. Thus, frame member 52 may include a finger 60, an arm 62 and a leg 64, frame member 54 may include a finger 66, an arm 68 and a leg 70, frame member 56 may include a finger 72, an arm 74 and a leg 76, and frame member 58 may include a finger 78, an arm 80 and a leg 82. Each frame member 52, 54, 56, 58 may be arranged so that the their respective fingers are angled with respect to their respective arms, and their respective arms are angled with respect to their legs. In some embodiments, the free or lower ends of the legs may be attached to the base 12 and so that portions of them are in generally vertical aligned with an axial centerline 51 of the cradle 50. In a preferred implementation, the free or lower ends of the legs may be attached to the platform 40 so that substantial portions of them are in generally vertical alignment with the axial centerline 51 of the cradle 50. The arms of the frame members may extend upwardly and in a radially divergent manner, and the fingers extend radially from upper ends thereof. As shown, a radially extending end of the finger of each frame member may be connected to an upper crossbeam. It will be understood, however, that in some embodiments, fingers may be omitted and the upper ends of the arms may be connected directly to the upper crossbeams. Further, it will be appreciated that the frame members need not be angular in nature. Instead, portions of the frame members may be curved and the frame members may assume arcuate or sinuous configurations without departing from the spirit and scope of the invention.

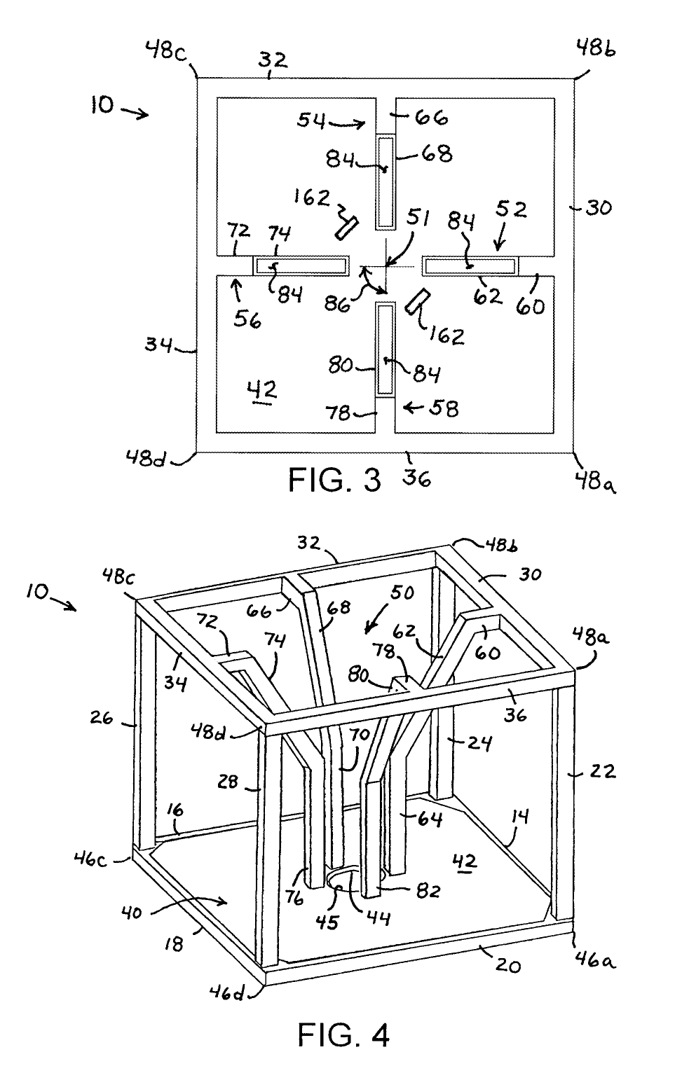

With regard to the alternative embodiment of FIG. 3, the frame members 52, 54, 56 and 58 may be arranged about the axial centerline 51 of the cradle 50, which may coincide with an axial centerline of the safety appliance 10. Preferably, each frame member may be spaced from each other by a pre-determined angle 86, with the angle having a range from approximately 180 degrees or less, and preferably a range of approximately 120 degrees to approximately 30 degrees. The angle may be derived by dividing the number 360 by the number of frame members that form a particular cradle 50. In some embodiments where there are four frame members, the pre-determined angle would be approximately 90 degrees. In other embodiments where there are three frame members, for example, the pre-determined angle would be approximately 120 degrees, while in embodiments having five frame members the pre-determined angle would be approximately 72 degrees.

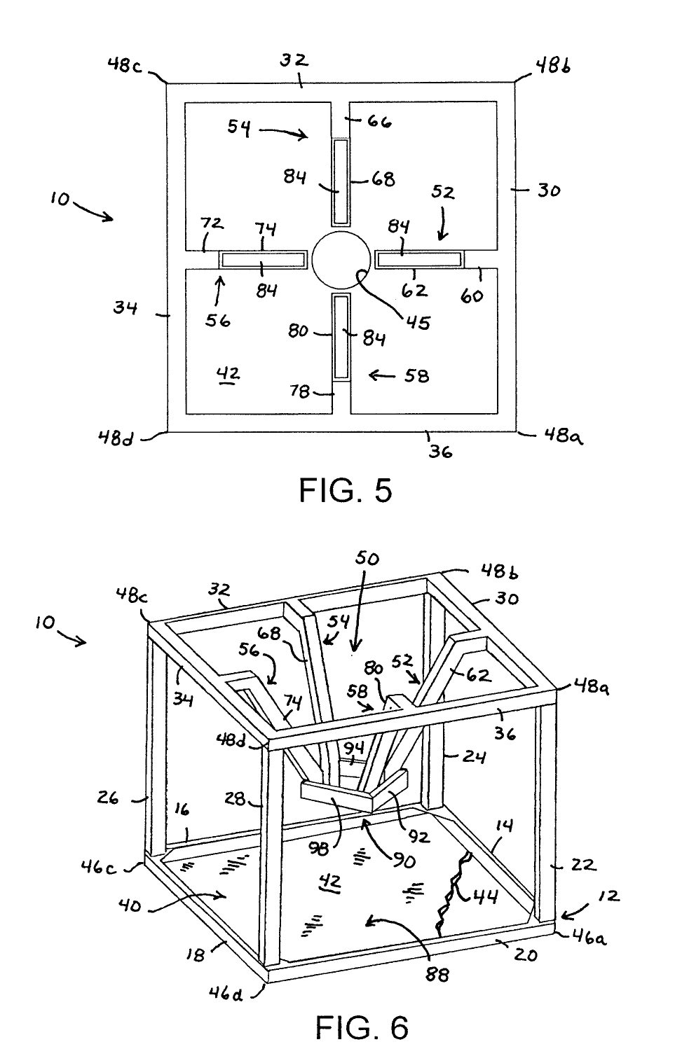

In use, a downhaul weight will be supported by one or more arms of the frame members that form the cradle. As will be understood, downhaul weights may be quite heavy and may exceed several hundred pounds. Further, there may be situations where after a downhaul weight has been received and seated in a cradle, repositioning may be necessary. Therefore, in some embodiments one or more of the arms may include a friction reducing element 84 as shown in the embodiments of FIGS. 3 and 5. The friction reducing element may take several forms. For example, a friction reducing element may comprise a strip of plastic material, such as nylon, acetal or polytetrafluoroethylene (PTFE). Preferably, though, the friction reducing element material is a thermoplastic polyethylene such as high-molecular-weight polyethylene or ultra-high-molecular weight polyethylene (UHMWPE), which have low coefficients of friction, tend to be self-lubricating and have a high resistance to abrasion. Preferably, the strip of friction reducing material is attached to an upwardly facing surface of an arm. In some embodiments, the strip of friction reducing material may be partially received in a recess in an arm. In other embodiments, the strip of friction reducing material may be attached to an upwardly facing surface of an arm by suitable adhesive material. In some embodiments, a strip of friction reducing material may be attached to upwardly facing surfaces of some of the arms or all of the arms. Alternatively, in some embodiments, a friction reducing element may be in the form of a sleeve (not shown) that can be positioned over an arm. For example, a sleeve could be in the form of a tube that is slid onto an arm from either end of a frame member, prior to assembly of the safety appliance. Alternatively, the sleeve could be in the form of a sheet of material that can be wrapped around an arm and secured with suitable fastening elements. The friction reducing sleeve itself may take several forms. For example, in some embodiments, a substantial portion of the sleeve may comprise friction reducing material. In other embodiments, the sleeve may include a layer of friction reducing material and a layer of friction enhancing material. In yet other embodiments, the sleeve may comprise friction enhancing material as a primary layer and the friction reducing layer may be in the form of an external band that extends longitudinally along the sleeve. Alternatively, the arm itself may be partially or totally formed from friction reducing material. The provision of a friction reducing element enables a downhaul weight to be manipulated and rotated as it resides in the cradle. So, for example, if a downhaul weight needed to be inspected, serviced, or positioned in a particular orientation, the use of a lifting device such as a crane may be avoided.

Referring now to FIGS. 4-5, an illustrative embodiment may include a platform 40 with an aperture 45. The aperture 45 may be located within an area defined by the legs 64, 70, 76, 82 of frame elements 52, 54, 56, 58. Advantageously, the aperture 45 can increase the vertical working distance beneath the cradle by utilizing a portion of the space that exists between the bottom surface 44 the platform 40 and the surface on which the appliance 10 rests. This additional working distance is the thickness of a lower crossbeam. As will be appreciated, a downwardly extending implement such as a hook can be more easily manipulated. The vertical working distance beneath the cradle can be further increased by providing one or more rails or box-beams onto which the safety appliance may be positioned (see also, FIG. 10).

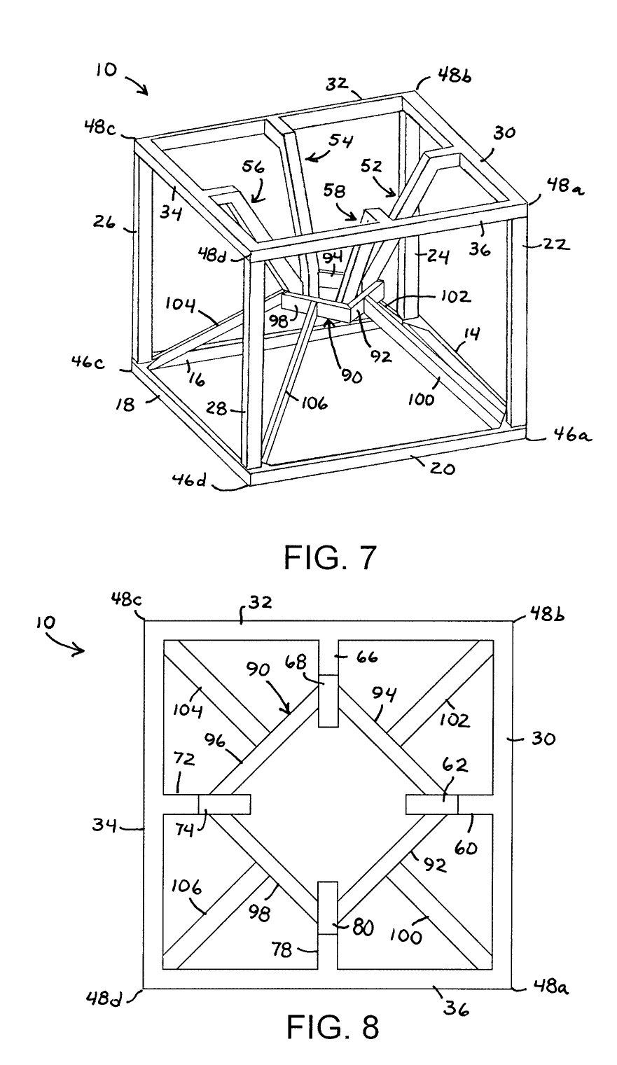

Turning now to FIG. 6, an illustrative embodiment may include frame members 52, 54, 56, 58 that may exclude one or more or their respective legs 64, 70, 76, 82. In a preferred embodiment, none of the frame members 52, 54, 56, 58 includes a leg. By omitting one or more of the frame member legs, additional working space below the cradle 50 is created. In situations where a downhaul weight includes downwardly extending peripheral attachment means such as a hook that extends below the cradle, the hook can be readily accessed without having to reposition the downhaul weight as it resides in the cradle. As will be appreciated, there exists a potential that one or more of the free or lower ends of the arms 62, 68, 74, 80 could splay outwardly and allow the weight to fall through the bottom of the cradle 50. To prevent such a failure, some cradle embodiments may be provided with a keeper structure 90. The keeper structure 90 may be connected to free or lower ends of the arms 62, 68, 74, 80, preferably at one or more outwardly facing surfaces of the arms. In some embodiments, the keeper structure 90 may include one or more crossbars 92, 94, 96, 98 that substantially encircle or gird the lower ends of the arms. In other embodiments, the keeper structure 90 may be in the form of a ring structure (not shown). Since the main purpose of the keeper structure is to prevent splaying of the free ends of the arms, it need not be connected directly to the arms. However, it is preferred that the keeper structure is connected to at least one arm, and more preferably to most, if not all of the arms. To further increase the usable working space below the cradle, some embodiments may omit a portion of the platform 40 by providing an aperture 45 such as depicted in the embodiment of FIGS. 4 and 5. In some embodiments, the entire platform may be omitted (see, for example, FIG. 7). In the exemplary third embodiment of FIG. 6, the platform 40 may be attached to the bottom edges of the lower crossbeams 14, 16, 18, 20 so as to form an upwardly opening receptacle or pan 88 into which ancillary downhaul weight items, tools, retaining members, ballast, etc. may be placed.

With reference to FIGS. 7 and 8, some embodiments of a safety appliance may include one or more elements such as a strut or brace 100, 102, 104, 106. The strut or brace can be used with cradles that do not have legs, such as the embodiment of a safety appliance depicted in FIG. 6. Instead of having legs that are parallel to each other and which connect respective arms of frame members to a platform, one or more struts 100, 102, 104, 106 may be arranged in a downwardly divergent manner and may connect a keeper structure 90 to the frame of the safety appliance 10, such as at one or more lower crossbeams 14, 16, 18, 20, or one or more posts (not shown). In a preferred embodiment, the struts 100, 102, 104, 106 may extend from lower corners or vertices 46a, 46b, 46c, 46d of the base 12 to crossbars 92, 94, 96, 98 of a keeper structure 90. Preferably, the struts extend from lower vertices 46a, 46b, 46c, 46d towards an oppositely situated upper vertices 48c, 48d, 48a, 48b, respectively (i.e. in generally diagonal directions). As will be appreciated, the keeper structure 90 need not be connected to one or more of the arms in order to satisfy its primary function. Instead, the keeper structure 90 need only prevent the arms from splaying outwardly, as discussed above. However, the struts 100, 102, 104, 106, the keeper structure 90 and the arms 62, 68, 74, 80 of the frame members 52, 54, 56, 58 may be connected to each other to provide a more robust safety appliance 10. In embodiments of safety appliances that include struts, it will be appreciated that the safety appliance may be inverted so that the struts are able to receive a downhaul weight in the same manner as a downhaul weight is received by the cradle 50.

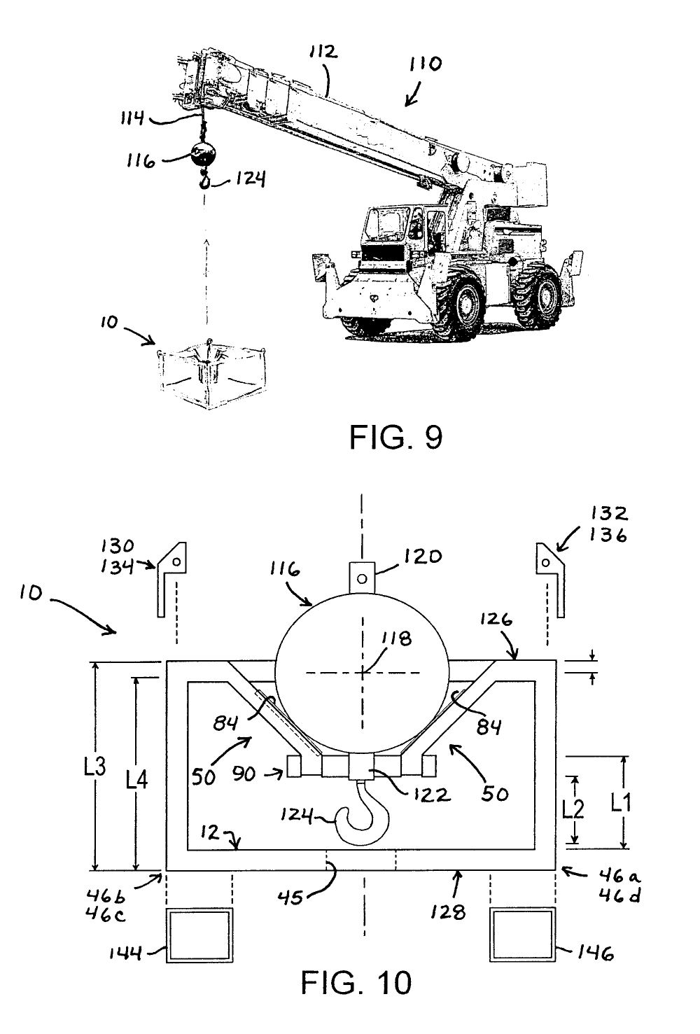

An embodiment of a safety appliance 10 as it may be used in conjunction with a crane 110 having a boom 112, a lifting cable 114 and a downhaul weight 116 is illustrated in FIG. 9. As depicted, the steps of moving the safety appliance, placing the safety appliance on a level surface and aligning the boom 112 and cable 114 with a cradle 50 of the safety appliance have already been performed, and a downhaul weight 116 has been positioned so that it is able to be received by the safety appliance 10.

An exemplary method of disconnecting a downhaul weight from a lifting cable may include steps such as:
a. providing a safety appliance the safety device comprising:
   a framework; and
   a cradle connected to the framework, with the cradle including a downhaul weight receiving portion;
   wherein the downhaul weight receiving portion diverges upwardly and outwardly, wherein the downhaul weight receiving portion is configured and arranged to receive the downhaul weight in an upright, working position, and wherein the downhaul weight receiving portion is able to resist lateral movement of the downhaul weight;
b. moving the appliance to a desired location (This may be accomplished by any number of ways, such as transporting it by a conveyance);
c. placing the appliance on a suitable, generally level surface;
d. positioning a downhaul weight so that it is substantially directly above the cradle of the safety appliance (This may be accomplished by either moving/raising the downhaul weight, by moving the safety appliance, moving both the downhaul weight and the safety appliance, moving the lifting device or a portion of the lifting device such as a boom, etc.);
e. lowering the downhaul weight until it contacts the cradle;
f. seating the downhaul weight in the cradle; and
g. disconnecting the lifting cable from the downhaul weight.
   Subsequent additional steps may include:
h. dismantling the downhaul weight, if desired (This may include sub-steps such as inspecting and replacing parts, if needed. This may also include a sub-step such as reorienting the downhaul weight if needed or desired—which may be accomplished by moving the downhaul weight while it resides in the cradle); and
i. securing the downhaul weight to the appliance (This can be accomplished by using one or more retaining members that engage portions of both the downhaul weight and the safety appliance. From this point, the safety appliance and the downhaul weight may be moved as a unit).

In a subsequent step, the safety appliance and downhaul weight may be conveyed to another location (This may be accomplished by one or more sub-steps such as: lifting the safety appliance by a lifting cable connected to the downhaul weight; using one or more lifting lines or a lifting sling connected to the safety appliance by one or more lifting lugs; or by using a forklift or similar conveyance to lift the safety appliance from below. This last alternative step may be facilitated by one or more rails or box-beams positioned underneath the safety appliance).

An exemplary method of connecting a downhaul weight to a lifting cable may include steps such as:
a. providing the combination of a safety appliance and a downhaul weight, the safety appliance comprising: a framework; and a cradle connected to the framework, with the cradle including a downhaul weight receiving portion; wherein the downhaul weight receiving portion faces upwardly and the downhaul weight is retained in an upright, working position;
b. connecting the lifting cable to the downhaul weight; and
c. moving the lifting cable in a vertical direction until the downhaul weight is free of the appliance.

Step “a” may be preceded by a step such as moving the combination or the lifting cable such that the downhaul weight and lifting cable are in substantial vertical alignment with each other; the step of disengaging any retaining members, if any; and sub-steps such as inspecting and replacing parts, if needed. This may also include a sub-step such as reorienting the downhaul weight if needed or desired—which may be accomplished by moving the downhaul weight while it resides in the cradle.

Another embodiment of a safety appliance 10 in combination with a downhaul weight 116 is shown in FIG. 10. Here, the downhaul weight 116 is of the type having elements such as a substantially spherical weight having a center of gravity 118, a lifting cable attachment member 120, a hook attachment member 122 and a hook 124. The downhaul weight 116 is seated in the cradle 50 of the safety appliance 10 in an upright orientation such as one would expect to find when the downhaul weight is normally connected to a lifting cable. In such an orientation, the downhaul weight 116 is supported by the cradle 50, the hook attachment member 122 is adjacent the keeper structure 90, and the hook 124 extends below the cradle 50 where it can be accessed and manipulated. More particularly, the cradle 50 positions the downhaul weight 116 so that a vertical working distance L1 from the bottom of the downhaul weight to the base 12 of the safety appliance 10 is greater than a vertical length L2 of the hook 124 from its attachment point to the hook attachment member 122 to the bottom of the hook. In this vertically oriented, seated condition, note that the center of gravity 118 is lower than the top 126 of the safety appliance 10. Note that the difference between L1 and L2 may be increased by providing an aperture 45 (shown in phantom; see also, FIGS. 4 and 5) into which the hook 124 may protrude. In addition, the cradle 50 positions the downhaul weight 116 so that a vertical distance L3 defined by the top 126 and a bottom 128 of the safety appliance 10 is preferably equal to or greater than a vertical distance L4 defined by the bottom 128 and the center of gravity 118 of the downhaul weight 116. As will be appreciated, the ability of the safety appliance 10 to hold a downhaul weight 116 so that its center of gravity 118 is at or below the top 126 of the safety appliance will increase the stability of the combination of the safety appliance and a downhaul weight. In addition, such ability may advantageously reduce the tendency of a downhaul weight to accidently become unseated from a cradle under the influence of one or more lateral forces.

While some embodiments of a safety appliance 10 may be light enough to be able to be moved by hand when empty, this is not necessarily true for combinations of safety appliances and downhaul weights—particularly if the downhaul weight is oversized and the combination needs to be lifted up to a higher position. In order to facilitate lifting from above, some embodiments of safety appliances may be provided with one or more lifting lugs 130, 132, 134, 136. The lifting lugs may be connected to the safety appliance and can serve as attachment points for a lifting sling, for example (see, FIG. 12). In some embodiments, the lifting lugs may be removably connected to the safety appliance by fastening elements such as nuts and bolts, clevis pins, etc. In other embodiments, the lifting lugs may be permanently connected to the safety appliance as, for example, by welding. In some embodiments, the lifting lugs may be connected at the upper vertices 48a, 48b, 48c, 48d of the safety appliance.

In order to facilitate lifting the appliance from below, some embodiments of safety appliances may be provided with one or more box-beams, rails or pedestals 144, 146 (FIGS. 10-12). The box-beams 144, 146 depicted may be connected to the bottom 128 of a safety appliance and their intrinsic socket structures may receive tines of a lifting apparatus, such as a fork lift, a pallet jack, or a crane pallet fork, for example. Alternatively, the box-beams 144, 146 can define a horizontal space therebetween that can receive one or more tines of a lifting apparatus. In some embodiments, the box-beams 144, 146 may be removably connected to the bottom 128 of the safety appliance 10 by fastening elements such as nuts and bolts. In other embodiments, the box-beams 144, 146 may be permanently connected to the safety appliance as, for example, by welding. In some embodiments, the box-beams 144, 146 may be connected to the safety appliance so that they are adjacent the lower vertices 46a, 46b, 46c, 46d of the safety appliance. Some embodiments of safety appliances 10 may be provided with lifting lugs 130, 132, 134, 136, and box-beams 144, 146. With such embodiments, stacking of similar safety appliances may be facilitated be removing portions 148 of the box-beams to provide spaces for lifting lugs of a lower safety appliance (see, for example FIG. 12, no. 148). Alternatively, the box-beams or rails, may be foreshortened or repositioned to essentially achieve the same result.

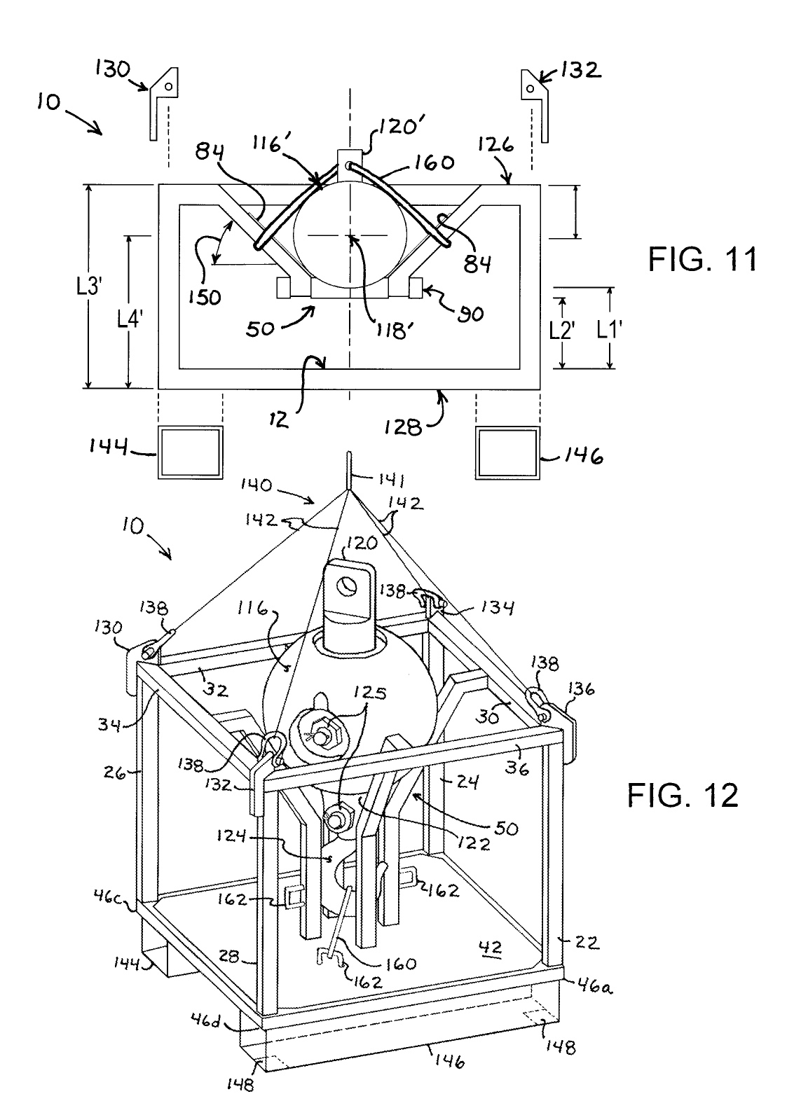

Turning now to FIG. 11, a combination of a safety appliance 10 and a differently sized downhaul weight 116′ is shown. Here, the downhaul weight 116′ is significantly smaller than downhaul weight 116 of FIG. 10. The downhaul weight 116′ of FIG. 11 has a center of gravity 118′ and a lifting cable attachment member 120′, but does not necessarily include a hook attachment member or a hook. More particularly, the cradle 50 positions the downhaul weight 116′ so that a vertical working distance L1′ from the bottom of the downhaul weight to the base 12 of the safety appliance 10 is greater than a vertical length L2′ defined by the bottom of the keeper structure and the base 12 of the safety appliance 10. Note that the working distance L1 may be increased by providing an aperture 45 (see, for example, FIGS. 4 and 5). In addition, the cradle 50 positions the downhaul weight 116′ so that a vertical distance L3′ defined by the top 126 and a bottom 128 of the safety appliance 10 is preferably equal to or greater than a vertical distance L4′ defined by the bottom 128 and the center of gravity 118′ of the downhaul weight 116′. In this vertically oriented, seated condition, note that the center of gravity 118′ is significantly lower than the top 126 of the safety appliance 10. As will be appreciated, the ability of the safety appliance 10 to hold a downhaul weight 116′ so that its center of gravity 118′ is below the top 126 of the safety appliance will increase the stability of the combination of the safety appliance and a downhaul weight. In addition, such ability may advantageously reduce the tendency of a downhaul weight to accidently become unseated from a cradle under the influence of one or more lateral forces. In some embodiments, the angle 150 formed by the arms and a horizontal line has a range of approximately 20 degrees to approximately 70 degrees. In other, embodiments, the angle has a range of approximately 30 degrees to approximately 60 degrees. In an exemplary embodiment, the angle is approximately 45 degrees.

Another exemplary embodiment of a safety appliance in conjunction with a downhaul weight is depicted in FIG. 12. Here, a downhaul weight 116 is supported by a cradle 50 such that it is maintained in its working orientation. A hook attachment member 122 and a hook 124 hang freely below the downhaul weight 116. In this orientation, fastening elements 125 (e.g. transverse nuts and bolts) are easily accessible and the hook attachment, the hook and the lifting cable attachment member can be removed, inspected and serviced, if needed or desired. The lifting lugs 130, 132, 134, 136 are connected by shackles 138 to a lifting sling 140 that includes a master link 141 and lifting lines 142. If a lifting sling is not used, the safety appliance may be conveyed by a forklift, a pallet jack, a crane pallet fork, or the like. To facilitate lifting from below, the appliance 10 may be provided with one or more box-beams, rails, or pedestals 144, 146 that elevate the bottom 128 of the appliance above a support surface. If the safety appliance 10 is not provided with box-beams, rails or pedestals 144, 146, the appliance may still be conveyed by a forklift, or a crane pallet fork or the like, wherein the forks may engage upper crossbeams 30, 32, 34, 36 from below.

It may be desirable to prevent a downhaul weight from being accidentally or inadvertently dislodged and separated from its resting position in a cradle. This may be accomplished with the provision of a retaining member (not shown). In some embodiments, a retaining member may be in the form of a flexible member such as a strap, wire, cable, chain, or the like that is configured and arranged to engage the cradle and a portion of a downhaul weight. For example, a retaining member may be configured so that it can engage two arms of a cradle and a lifting cable attachment member of a downhaul weight. In a preferred implementation, a retaining member can be fed through an aperture in the lifting cable attachment member and the opposing ends of the retaining member are looped about arms of the cradle. The retaining member may be provided with one or more fastening elements that facilitate attachment to the cradle arms.

In another embodiment, a retaining member may engage a plurality of portions of a cradle and a lifting cable attachment member of a downhaul weight (not shown). In one implementation, a retaining member may be provided with an aperture that is sized to fit about the upwardly extending body of a lifting cable attachment member so that a portion of the retaining member can reside on the downhaul weight. Ends of the retaining member may be looped about arms of the cradle and secured thereto with fastening elements such as hook and loop type fasteners.

In some embodiments, a retaining member may engage a hook of a downhaul weight and the framework of the safety appliance and be looped between one or more tie-down rings, such as D-rings that may be connected to the framework of the safety appliance (not shown). In preferred embodiments, the tie-down rings are b-rings, which may be connected to the platform of the safety appliance. Alternatively, the tie-down rings may be connected to one or more legs of one or more frame members. Other types of retaining member fastening elements and retaining member connection points are possible without departing from the spirit and scope of the invention.

The foregoing is considered as illustrative only. Furthermore, since numerous modifications and changes will readily occur to those skilled in the art, the exact constructions and operation shown and described are only examples of preferred embodiments. The invention is defined by the following claims.

What is claimed is:

1. A safety appliance useable for attachment and removal of a downhaul weight from a lifting cable, the safety appliance comprising:
a framework; and
a cradle connected to the framework, with the cradle including a center axis and a downhaul weight receiving portion;
wherein the downhaul weight receiving portion faces upwardly and is configured and arranged to receive the downhaul weight in an upright, working position when the lifting cable lowers the downhaul weight into the cradle.

2. The safety appliance of claim 1, wherein the cradle includes a plurality of frame members each having an upwardly facing surface, wherein at least one of the upwardly facing surfaces engages the downhaul weight when the downhaul weight is positioned in the cradle.

3. The safety appliance of claim 2 wherein the upwardly facing surfaces of the frame members are angled with respect to the vertical.

4. The safety appliance of claim 2, wherein the upwardly facing surfaces are radially arranged with respect to the center axis of the cradle.

5. The safety appliance of claim 1, wherein the cradle includes a lower end that defines an opening that is sized to freely admit an appendage that is connected to the bottom end of the downhaul weight.

6. The safety appliance of claim 3, wherein the cradle further includes a keeper structure and wherein each frame member includes an arm with a lower end, at least one of the lower ends of the arms is connected to the keeper structure.

7. The safety appliance of claim 2, wherein at least one of the upwardly facing surfaces includes a friction reducing material.

8. The safety appliance of claim 1, further comprising one or more rails, wherein the rails are configured and arranged to be connected to the safety appliance from below.

9. The safety appliance of claim 5, wherein the framework further comprises a plurality of interconnected lower crossbeams and a platform, wherein the platform is connected to at least one of the plurality of lower crossbeams.

10. The safety appliance of claim 9, wherein the platform includes an aperture having a center that is in substantial alignment with the center axis of the cradle.

11. The safety appliance of claim 10, wherein the aperture is sized to freely admit the appendage that is connected to the bottom end of the downhaul weight.

12. The safety appliance of claim 1, wherein the cradle includes a lower end, wherein the appliance further comprises a strut and a base; and wherein the strut connects the lower end of the cradle to the base of the safety appliance.

13. The safety appliance of claim 12, wherein the strut is angled with respect to the vertical.

14. The safety appliance of claim 12, wherein the base of the safety appliance includes a lower vertex, and wherein the strut extends in a direction toward the lower vertex of the base.

15. The safety appliance of claim 12, wherein there is a plurality of struts that are radially arranged with respect to the center axis of the cradle.

16. The safety appliance of claim 8, wherein the rails are box-beams.

17. The safety appliance of claim 1, further comprising a lifting lug, wherein the lifting lug is connected to the framework.

18. The safety appliance of claim 1, wherein the framework comprises a plurality of interconnected lower crossbeams, a plurality of interconnected upper crossbeams and a plurality of posts connecting the lower crossbeams to the upper crossbeams.

19. The safety appliance of claim 18, wherein the plurality of posts are substantially parallel with respect to each other.

20. The safety appliance of claim 1, wherein the framework includes a top and a bottom, wherein the cradle extends between the bottom and the top, and wherein a portion of the cradle diverges outwardly as it extends upwardly towards the top.

21. The safety appliance of claim 1, further comprising a retaining member, the retaining member configured and arranged to secure the downhaul weight to the safety appliance.

22. A method of disconnecting a downhaul weight from a lifting cable, the method comprising the steps of:
a. providing a safety appliance, the safety appliance comprising:
a framework; and
a cradle connected to the framework, with the cradle including a downhaul weight receiving portion;
wherein the downhaul weight receiving portion diverges upwardly and outwardly, wherein the downhaul weight receiving portion is configured and arranged to receive the downhaul weight in an upright, working position, and wherein the downhaul weight receiving portion is able to resist lateral movement of the downhaul weight;
b. positioning the downhaul weight substantially directly above the cradle of the safety appliance;
c. lowering the lifting cable until the downhaul weight contacts the cradle; and
d. disconnecting the lifting cable from the downhaul weight.
